(19) United States
(12) Patent Application Publication
(10) Pub. No.: US 2012/0085603 A1
(43) Pub. Date: Apr. 12, 2012

(54) Brake Disk

(75) Inventors: Ralph Mayer, Ingolstadt (DE); Matthias Mitschang, Esslingen (DE)

(73) Assignee: Daimler AG, Stuttgart (DE)

(21) Appl. No.: 13/255,019

(22) PCT Filed: Feb. 11, 2010
(86) PCT No.: PCT/EP2010/000863

§ 371 Date: Nov. 18, 2011

(30) Foreign Application Priority Data
Mar. 7, 2009 (DE) 10 2009 012 216.8

(51) Int. Cl. F16D 65/12

(52) U.S. Cl. 188/218 XL

(57) ABSTRACT

A brake disk for a motor vehicle is provided. The brake disk includes a brake disk chamber and a friction ring arranged coaxially thereto, an outer casing surface of the brake disk chamber having a profile, which for torque transmission, engages in a complementary profile of an inner casing surface of the friction ring, and the friction ring being arranged axially secured to the brake disk chamber. At least one tab for axial securing is formed on the outer casing surface of the brake disk chamber.

### BACKGROUND AND SUMMARY OF THE INVENTION

The invention relates to a brake disk for a motor vehicle.

In so-called composite brake disks, i.e. brake disks, the friction ring and brake disk chamber are typically made of different materials. DE 198 30 666 A1 discloses an example of known composite disk brakes. Composite brake disks are being increasingly used, since the separation of the brake disk chamber and friction ring means that the aforementioned parts can, each taken individually, be optimized for their use. Thus, it is possible to combine friction rings made of cast iron, which has excellent tribological and heat conduction properties, with brake disk chambers made of sheet metal, in order to make the entire brake disk lighter and hence to reduce the unsprung mass of a motor vehicle with such a brake disk.

In order to join the brake disk chamber to the friction ring, DE 198 30 666 A1 teaches providing a profile on an inner periphery of the friction ring and pressing the brake disk chamber against this profile by hydroforming.

Disadvantageously, hydroforming is an expensive process which involves relatively high production costs. Since the hydroforming of the brake disk chamber produces play-free seating of the friction ring on the brake disk chamber in both the radial and in the axial direction, brake disks joined in such a manner furthermore have the disadvantage that there is no margin for compensating for different thermal expansion of the friction ring and brake disk chamber.

Furthermore, WO 96/41967 A1, US 2007/0284200 A1, GB 1 298 811 A and DE 44 20 758 A1 each disclose built-up brake disks in which radially protruding holding elements are provided on an outer casing surface of a brake disk chamber, which elements lie at least in part against an end face of a friction ring and serve to produce axial securing between the brake disk chamber and friction ring. In addition, the brake disk chambers disclosed in WO 96/41967 A1, US 2007/0284200 A1 and GB 1 298 811 A have an annular bearing surface on which the friction ring can be supported, which provides further axial securing between the brake disk chamber and friction ring. In contrast to this, DE 44 20 758 A1 discloses further axial securing between the brake disk chamber and friction ring in the form of embossings provided on the outer casing surface of the brake disk chamber.

What all the brake disks disclosed in WO 96/41967 A1, US 2007/0284200 A1, GB 1 298 811 A and DE 44 20 758 A1 have in common is that there is no margin for compensating for different thermal expansion of the friction ring and brake disk chamber.

The present invention provides a brake disk whose production is simplified and has greater structural margins in the configuration of axial and radial securing of the brake disk chamber against the friction ring.

In accordance with exemplary embodiments of the present invention, a brake disk has a brake disk chamber and a friction ring arranged coaxially thereto, an outer casing surface of the brake disk chamber having a profile, which for torque transmission, engages in a complementary profile of an inner casing surface of the friction ring. Furthermore, axial securing of the friction ring relative to the brake disk chamber is provided, at least one radially protruding holding element being formed on an edge of the outer casing surface of the brake disk chamber, which element lies against an end face of the friction ring. According to the invention, this axial securing is provided by at least one tab on the outer casing surface of the brake disk chamber, with floating mounting of the friction ring on the brake disk chamber being attained by a respective distance between the tab and holding element.

In contrast to solutions known partially from the prior art, the profile of the brake disk chamber thus assumes only the function of radial securing, i.e. the torque transmission between the brake disk chamber and friction ring. The axial securing is carried out by a separate element, namely a tab. Unlike other known methods of axial securing—such as for example rivets, bolts, screws—no additional connecting elements are necessary to hold the friction ring secured in the axial direction on the brake disk chamber. This simplifies production of the brake disk and thereby saves on costs. Moreover, additional securing of the friction ring in the axial direction is ensured by the holding element, again with no additional connecting elements being necessary. Just like the tab on the outer casing surface which has already been described, this holding element may be produced by a simple, single-step forming process.

In a further embodiment, additional elements for axially directed securing can be dispensed with by joining the chamber relative to the friction ring with an overdimension that is sufficiently dimensioned in the temperature range upon braking.

In a preferred embodiment of the invention, the tab for axial securing is punched out of the wall of the brake disk chamber and is bent over. This can advantageously take place in a single operating step with a suitable tool, so that particularly simple production of the brake disk according to the invention is made possible.

The tab can alternatively engage in an opening in the friction ring or lie against a surface of the friction ring. Thus, there is also the structural freedom to provide a certain play when axially securing the friction ring relative to the brake disk chamber, i.e. to realize at least partially floating mounting. This means that, for example, different thermal expansions of the friction ring and brake disk chamber can be compensated in the operation thereof.

Alternatively, the function of an axially oriented stop can also be fulfilled by a bent section, which can likewise be realized in one operating step. This means that, if necessary, higher axial forces can also be supported than with radially formed tabs.

In a further embodiment, the profiles of the friction ring and brake disk chamber are formed as a set of teeth. This permits particularly good, low-load torque transmission between the brake disk chamber and friction ring.

Furthermore, the possibility of axial extension is provided by a holding element lying merely partially against the friction ring and in the intermediate region has a distance of the order of the thermal friction ring expansion or of the axial displacement requirement. This ensures an elastic/plastic nature of the stop. The combination of tab and holding element yields a particularly precise geometric positioning between the brake disk chamber and friction ring, which reduces the undesirable axial runout of the brake disk. The axial displaceability between the two components in this case is preferably prevented by an overdimension of the brake disk chamber.

Preferably, a flank angle of the set of teeth of the brake disk chamber is 55° to 65°. The set of teeth in this case is preferably formed asymmetrically, with a space width of the set of teeth of the friction ring being 4.5 to 6 mm and a space width of the set of teeth of the brake disk chamber being 7.5 to 9.5 mm. Such a narrow-meshed and asymmetrical set of teeth maximizes the torsional section modulus between the brake disk chamber and friction ring in a particularly material-saving manner.

Preferably, the brake disk chamber is made from steel. By so doing, advantageously electrochemical corrosion is avoided when the brake disk chamber is connected to a friction ring made of cast iron.

The invention furthermore relates to a motor vehicle with a brake disk of the type described.

### BRIEF DESCRIPTION OF THE DRAWING FIGURES

Below, the invention and its embodiments will be explained in greater detail with reference to the drawings. Therein:

FIG. 1 shows a perspective view of an example of embodiment of a brake disk according to the invention;

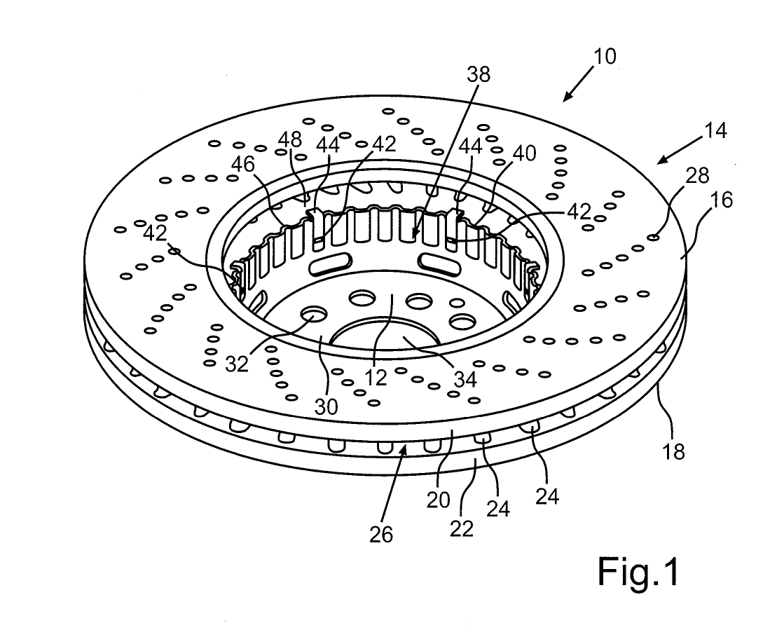

FIG. 2 shows a detail view of the axial and radial securing elements of such a brake disk, and

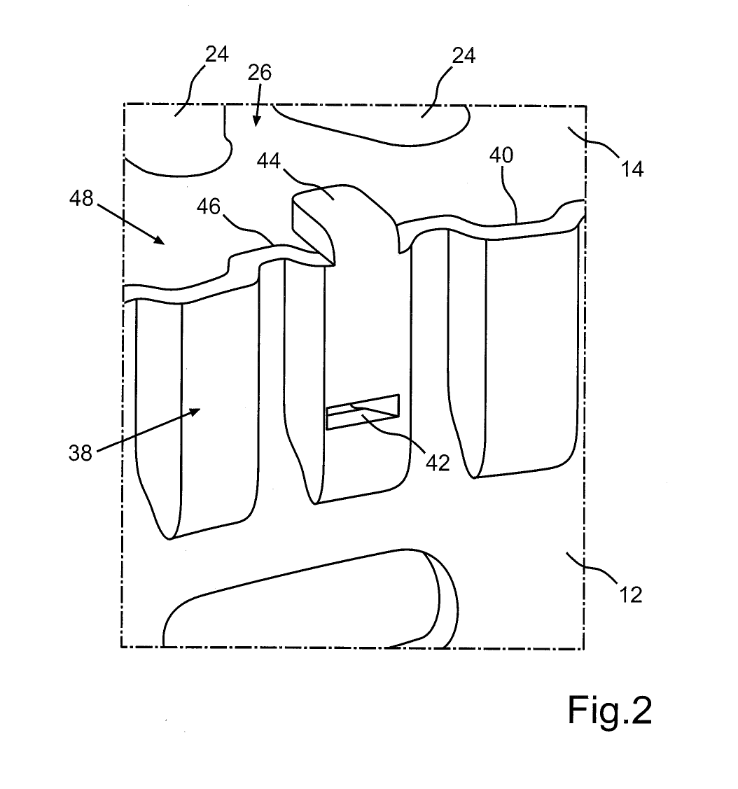

FIG. 3 shows a sectional view through the set of teeth between the brake disk chamber and friction ring of an example of embodiment of a brake disk according to the invention.

FIGS. 4A and B show a detail view of the axial and radial securing elements of such a brake disk in an alternative embodiment.

### DETAILED DESCRIPTION

A brake disk 10 comprises a brake disk chamber 12 and a friction ring 14. The friction ring has two friction surfaces 16, 18 which, during operation of the brake, come into tribological contact with the brake shoes. Owing to the particularly good friction properties, such friction rings 14, as a rule, are manufactured from cast iron, in particular gray cast iron. In order to dissipate the heat occurring during braking operation, the friction ring 14 is designed as an internally ventilated friction ring and consists of two friction ring halves 20, 22, which are connected together via connecting studs 24, which for clarity are not all designated. This forms channels 26 between the friction ring halves 20, 22 through which ambient air can flow and can thus dissipate heat. Also, channels 28 are formed in each case in the friction ring halves 20, 22 which open into the channels 26 and emerge on the friction surfaces 16, 18, in order further to improve the air flow through the friction ring 14.

The brake disk chamber 12 has an end face 30 in which openings 32, 34 are formed in order to connect the brake disk chamber to a hub. Furthermore, the brake disk chamber 12 has a casing wall 38, via which the brake disk chamber 12 is connected to the friction ring 14. Since no demands in terms of its friction properties are made on the brake disk chamber 12, it can be made from sheet metal (i.e., steel sheet), instead of from cast iron in order to save weight. In order to secure the brake disk chamber 12 and friction ring 14 against one another, the casing wall 38 of the brake disk chamber 12 has a toothed profile which engages in a complementary profile of an inner casing wall 40 of the friction ring 14. This achieves radial securing of the friction ring 14 relative to the brake disk chamber 12 so that torques can be transmitted between the two parts 12, 14. In order to bring about axial securing between the brake disk chamber 12 and friction ring 14, tabs 42 are punched out of the casing wall 38 which engage in complementary openings in the friction ring 14, which cannot be seen in the drawings. Further axial securing is produced by holding elements 44, which protrude radially outwards on the edge 46 of the casing wall 38 and lie against the inner surface 48 of the friction ring half 22. Alternatively, the tabs 42 may not engage in receiving openings in the friction ring half 22, but rather lie against the friction surface 18 of the second friction ring half 22. Owing to the respective distances between the tabs 42 and holding elements 44, floating mounting of the friction ring 14 on the brake disk chamber 12 can be achieved, so that a certain play in the axial direction remains. Thus, for example, different thermal expansions of the friction ring 14 and of the brake disk chamber 12 can be compensated.

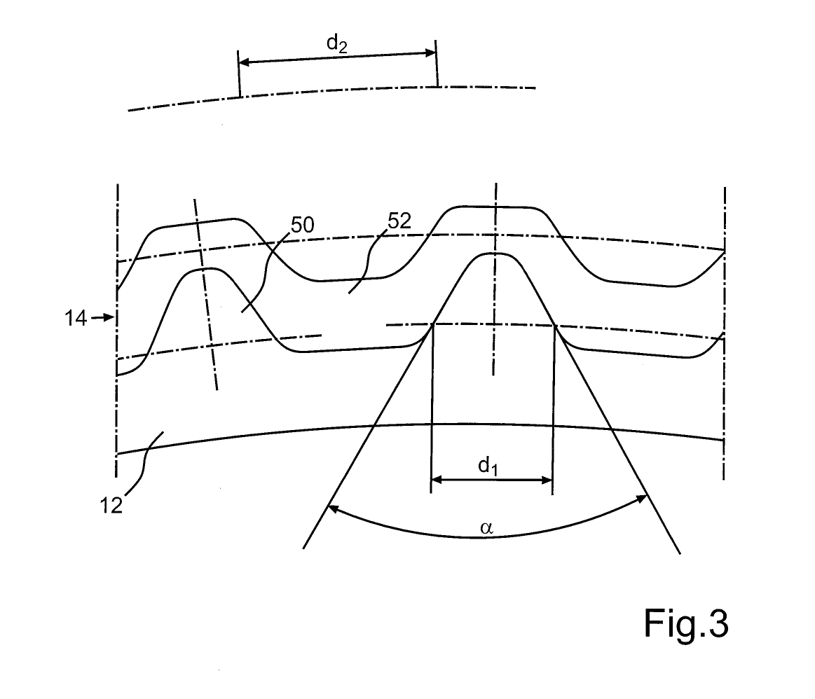

As can be inferred from FIG. 3, the set of teeth between the friction ring 14 and brake disk chamber 12 is formed asymmetrically, the teeth 50 of the brake disk chamber 12 being made narrower than the teeth 52 of the friction ring 14. The space width d1 of the set of teeth of the friction ring 14 in this case is 4.5 to 6 mm, and the space width d2 of the set of teeth of the brake disk chamber 12 is 7.5 to 9.5 mm. The flank angle α of the set of teeth of the brake disk chamber lies between 55° and 65°. Due to such an asymmetrical and narrow-meshed set of teeth of the brake disk chamber 12 and friction ring 14, particularly good, low-wear torque transmission between the brake disk chamber 12 and friction ring 14 is achieved.

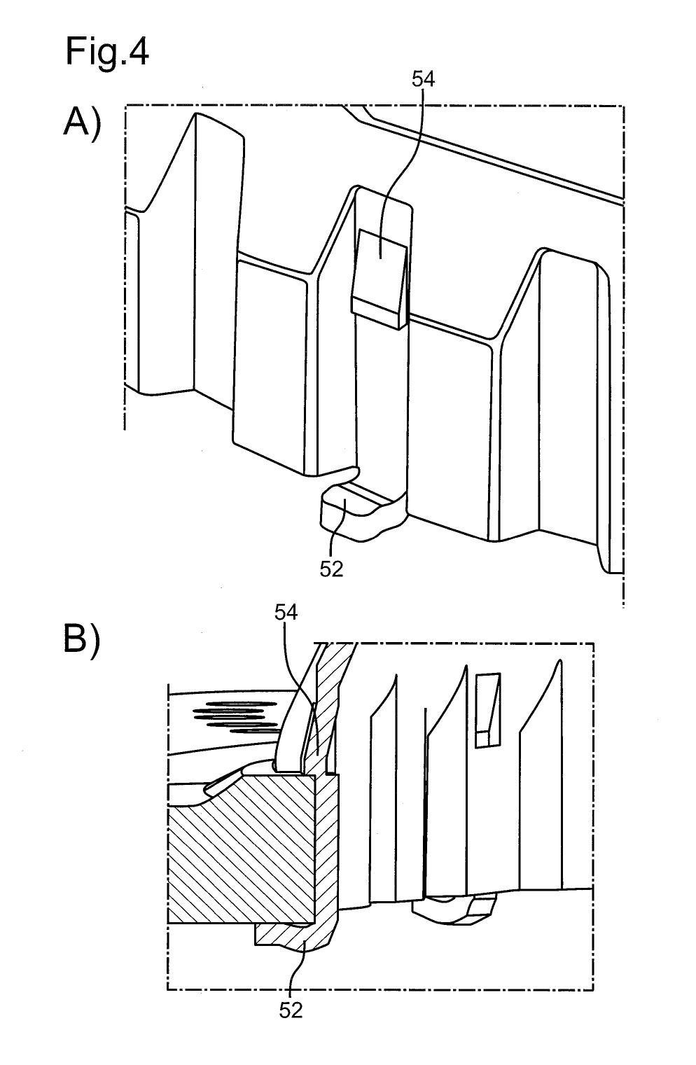

FIGS. 4A and B show an alternative embodiment, in which a tab 52 on the edge of the casing wall of the brake disk chamber engages around the friction ring, counter-securing being provided by a stop 54.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A brake disk for a motor vehicle, comprising:
a brake disk chamber;
a friction ring arranged coaxially with respect to the brake disk chamber;
wherein an outer casing surface of the brake disk chamber has a profile which, for torque transmission, is configured to engage in a complementary profile of an inner casing surface of the friction ring, the friction ring is arranged axially secured to the brake disk chamber, and at least one radially protruding holding element is arranged on an edge of the outer casing surface of the brake disk chamber, which element lies at least in part against an end face of the friction ring,
wherein at least one tab for axial orientation is arranged on the outer casing surface of the brake disk chamber, and the friction ring is floating mounted on the brake disk chamber by a respective distance between the tab and holding element.

15. The brake disc as claimed in claim 14, wherein the tab is punched out of a wall of the brake disk chamber and is bent over.

16. The brake disc as claimed in claim 15, wherein at least one bent section in the wall of the brake disk chamber is provided for axial orientation.

17. The brake disc as claimed in claim 14, wherein the tab engages in an opening in the friction ring or lies against a surface of the friction ring.

18. The brake disk as claimed in claim 14, wherein the holding element or the tab have an elastic/plastic characteristic.

19. The brake disk as claimed in one of claim 14, wherein the profiles of the friction ring and brake disk chamber are formed as a set of teeth.

20. The brake disc as claimed in claim 19, wherein a flank angle of the set of teeth of the brake disk chamber is 55° to 65°.

21. The brake disc as claimed in claim 19, wherein the set of teeth is formed asymmetrically between the friction ring and brake disk chamber.

22. The brake disc as claimed in claim 19, wherein a space width of the set of teeth of the friction ring is 4.5 to 6 mm.

23. The brake disc as claimed in claim 19, wherein a space width of the set of teeth of the brake disk chamber is 7.5 to 9.5 mm.

24. The brake disk as claimed in claim 14, wherein the brake disk chamber is made from steel.

25. A motor vehicle comprising:
a brake disk, which comprises
a brake disk chamber;
a friction ring arranged coaxially with respect to the brake disk chamber;
wherein an outer casing surface of the brake disk chamber has a profile which, for torque transmission, is configured to engage in a complementary profile of an inner casing surface of the friction ring, the friction ring is arranged axially secured to the brake disk chamber, and at least one radially protruding holding element is arranged on an edge of the outer casing surface of the brake disk chamber, which element lies at least in part against an end face of the friction ring,
wherein at least one tab for axial orientation is arranged on the outer casing surface of the brake disk chamber, and the friction ring is floating mounted on the brake disk chamber by a respective distance between the tab and holding element.
